(19) United States
(12) Patent Application Publication
(10) Pub. No.: US 2006/0221893 A1
(43) Pub. Date: Oct. 5, 2006

(54) System, network entity, method, mobile device and computer program product for correlating device identifiers in mobile networks

(75) Inventor: Krisztian Kiss, Del Mar, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/391,965

(22) Filed: Mar. 28, 2006

Related U.S. Application Data
(60) Provisional application No. 60/667,911, filed on Apr. 1, 2005.

(51) Int. Cl. H04Q 7/00

(52) U.S. Cl. 370/328

(57) ABSTRACT

A means by which a network-based presence source can ascertain the unique device ID for each device on the network based on the device's IP address is provided. In particular, a network-based Device ID database, along with a method of accessing and utilizing the database, which can be used in conjunction with any presence service to store binding, or correlating, information between the device IDs and device IP addresses for a plurality of devices communicating on the network are provided.

### CROSS-REFERENCE TO PROVISIONAL APPLICATION

The present application claims priority from U.S. Provisional Application No. 60/667,911 filed Apr. 1^{st}, 2005 and entitled “Method and Apparatus for Correlating Device Identifier in Mobile Networks,” the contents of which are hereby incorporated herein by reference in their entirety.

### FIELD OF THE INVENTION

Exemplary embodiments of this invention relate to wireless networks, and more particularly to a mechanism for correlating different device identification formats in wireless communication networks.

### BACKGROUND OF THE INVENTION

Wireless communication systems and networks, such as GSM (Global Systems for Mobile Communication), GPRS (General Packet Radio Service), Enhanced Data for GSM Evolution (EDGE), WCDMA (Wideband Code Division Multiple Access), and CDMA (Code Division Multiple Access), are used in connection with many applications, including, for example, portable communication devices (PCDs) (e.g., cellular telephones), personal digital assistants (PDAs), and laptop computers. One benefit of wireless communication networks is that they provide support for any number of portable communication devices within and between the networks.

Wireless communication systems include a plurality of users. PCDs, which are also known, for example, as mobile stations or mobile nodes, each function as an Internet Protocol (IP) client. A user may be any suitable device that is capable of communicating with a wireless network, such as a cellular telephone or a laptop computer with a wireless modem.

Wireless communication systems also include a plurality of base stations or base transceiver stations (BTSs) for managing wireless links to users. BTSs act as the interface between the network and users, in that they convert digital data into radio signals and vice versa. Each of the BTSs generally has an associated radio tower or antenna and communicates with various users using radio links. In particular, BTSs communicate with various users through the modulation and transmission of sets of forward signals, while BTSs receive and demodulate sets of reverse signals from various users that are engaged in a wireless network activity (e.g., a telephone call, Web browsing session, etc.)

BTSs connect to one or more base station controllers (BSCs) (e.g., using un-channelized T1 facilities or direct cables, although this is not required). BSCs are used to interface, or aggregate, all radio frequency (RF) traffic arriving from the antennas of the BTS, and to provide this traffic to a mobile switching center (MSC). As known in the art, BSCs are generally responsible for managing the radio resources for one or more BTSs. For example, BSCs may handle radio-channel setup, frequency hopping, and handovers. Moreover, the MSC is responsible for providing the interface between the radio access network (RAN), which includes the BTSs, BSCs, and Packet Control Functions (PCFs), and a public switched telephone network (PSTN).

A feature of many mobile devices included in these wireless communication systems is presence enabling, which allows users of these devices to determine whether other mobile devices are online and available for communication. Presence is defined as the availability and willingness (presentity) of a user or device for communication. Presence information, in the form of a variety of presence states, can be published by users to other system users, known as “watchers” or “subscribers,” to indicate the user's communication status. Status, or presence, information can generally be broken down into information related to (1) the user; (2) the device; or (3) the network services. This information may vary depending on the type of device. For instance, for cellular telephones or other mobile devices, the status information may include the user's geographic location and the latency of the network to which the mobile device is connected. Alternatively, the status information for a personal computer with a wired Internet connection may include, for example, whether the user is online.

Presence information has multiple sources, such as the user or device itself, or a network-based presence source, also known as a Presence Network Agent (PNA). A PNA publishes presence information any time the presence information state of any device on the network changes, such as, when a particular device's availability changes (e.g., when the device first attaches to the network). A network-based Presence Server manages the collection and controlled dissemination of the presence information over the network. In particular, the Presence Server aggregates the presence information received from the various sources and creates a presence document, which it then makes available to other users on the network. In order for the PNA to publish presence information relating to a particular device, and for the Presence Server to gather the information, it is necessary that each device be readily identifiable.

Various means are used to identify PCDs, and the coordination of network resources in order to efficiently allocate those resources is one challenge that handset manufacturers and service providers face. One means of identifying PCDs is through the use of a device identifier (ID). Device IDs are Universal Resource Identifiers (URIs) that act as globally and temporally unique identifiers for the devices. In particular, a device ID is a Universal Resource Name (URN), which must be unique across all other devices for a particular presentity. It is also highly desirable that the device ID be persistent across time, globally unique, and computable in a fashion so that different systems are likely to refer to the device using the same ID. Where a device ID exhibits these properties, differing sources of presence information based on device status can be combined together.

Unfortunately, due to the variety of different devices in existence, it is difficult for a single URN scheme having these properties to be used. It is anticipated that multiple schemes will be defined, with different schemes being appropriate for different types of devices. For instance, for cellular telephones, the Electronic Serial Number (ESN) or the International Mobile Equipment Identifier (IMEI), for example, are good identifiers, while for IP devices, the Media Access Control (MAC) address is another good identifier. Unfortunately, none of these identifiers are currently associated with URN schemes.

In the interim, a Universal Unique Identifier (UUID) URN can be used. A Universal Unique Identifier is an identifier standard used in software construction, standardized by the Open Software Foundation (OSF) as part of the Distributed computing environment (DCE). The intent of UUIDs is to enable distributed systems to uniquely identify information without significant central coordination. Thus, anyone can create a UUID and use it to identify something with reasonable confidence that that identifier will never be unintentionally used by anyone for anything else. Information labelled with UUIDs can therefore be later combined into a single database without need to resolve name conflicts. UUID URN has the properties of being globally and temporally unique. However, because of its random component, it is not useful as a correlation ID with other presence sources on a network.

In IP data networks, using the MAC address as the device ID has the clear advantage that it enables PNAs to publish presence information on behalf of devices correctly. The connectivity information is associated with the device's MAC address binding the device's MAC address to the currently used IP address. Dynamic Host Configuration Protocol (DHCP) servers store the correlation information between MAC addresses and IP addresses, so that by knowing the IP address of a particular PCD, a network-based presence source, or PNA, can query a DHCP server for the device's MAC address and publish presence information accordingly by inserting the device's MAC address as <deviceID> inside the <device> element in a SIP (Session Initiation Protocol) PUBLISH request as if the device were publishing.

In mobile networks, such as GSM, GPRS, or CDMA, the connectivity information is usually based on a service identifier. For example, in a GSM/GPRS environment, the Mobile Station Integrated Service Digital Network (ISDN) Number (MSISDN) is the key for connectivity information. When a mobile station (MS) attaches to the network, the Home Location Register (HLR) is updated with the information that the MSISDN is available for incoming communication. Furthermore, devices are allocated different types of identifiers. For example GSM/GPRS systems use an IMEI, while CDMA systems use the ESN.

Currently, there are no databases storing binding, or correlating, information between a mobile device's IP address and the relevant device identifier. Consequently, a need exists for providing a means by which a PNA that is publishing presence information on behalf of a mobile device can ascertain the device identifier for that device to be used for presence publication.

### BRIEF SUMMARY OF THE INVENTION

Generally described, embodiments of the present invention provide an improvement over the known prior art by, among other things, enabling a network-based presence source to ascertain the unique device ID for each device on the network based on the device's IP address.

According to one aspect of the present invention a system is provided for correlating one or more device identifiers associated with respective one or more mobile devices for use when publishing presence information relating to respective mobile devices. In one exemplary embodiment, the system includes a presence server and a device identifier (ID) database accessible by the presence server. The device ID database may store one or more device identifiers (IDs) associated with respective one or more mobile devices, as well as one or more IP addresses also associated with respective one or more mobile devices. The device ID database correlates the one or more device IDs and the one or more IP addresses associated with respective mobile devices, such that the database is capable of providing a device ID associated with a particular mobile device in response to receiving a query comprising an IP address also associated with the particular mobile device.

In one exemplary embodiment, the system further includes one or more mobile devices in communication with the presence server. The mobile devices may be configured to generate a request to publish presence information related to the mobile device, wherein the publication request includes a device ID associated with the mobile device. The mobile device may further be configured to transmit the publication request to the presence server. The presence server of this exemplary embodiment may be configured to receive the publication request, to ascertain an IP address associated with the mobile device from the publication request, and to determine, based at least in part on the IP address, whether a device ID associated with the mobile device has previously been stored in the device ID database.

The presence server of this exemplary embodiment may further be configured, upon a determination that a device ID associated with the mobile device has not previously been stored in the device ID database, to update the device ID database with the device ID and IP address associated with the mobile device. The presence server may further be configured, upon a determination that a device ID associated with the mobile device has previously been stored in the device ID database, to retrieve the previously stored device ID and to transmit the previously stored device ID to the mobile device. Alternatively, the presence server may further be configured, upon a determination that a device ID associated with the mobile device has previously been stored in the device ID database, to replace the previously stored device ID in the device ID database with the device ID included in the publication request.

In another exemplary embodiment, the system further includes a presence network agent in communication with the presence server and the device ID database. The presence network agent may be configured to query the device ID database for a device ID associated with a mobile device, and to generate a request to publish presence information related to the mobile device, wherein the request includes the device ID associated with the mobile device. The presence network agent may further be configured to transmit the publication request to the presence server.

The presence network agent of this exemplary embodiment may further be configured to receive, in response to querying the device ID database, the device ID associated with the mobile device. Alternatively, the presence network agent of this exemplary embodiment may further be configured to generate the device ID associated with the mobile device where, in response to querying the device ID database, a device ID is not returned. The presence network agent may further be configured to update the device ID database with the generated device ID correlated with an IP address associated with the mobile device.

In accordance with another aspect of the present invention, a network entity is provided that is configured to correlate one or more device identifiers associated with respective one or more mobile devices for use when publishing presence information relating to respective mobile devices. In one embodiment, the network entity includes a processor and a memory in communication with the processor, wherein the memory stores an application executable by the processor. The application may be configured, upon execution, to update a device identifier (ID) database with a device ID associated with a mobile device and correlated with an IP address also associated with the mobile device. The device ID database may store and correlate one or more device IDs and one or more IP addresses associated with respective one or more mobile devices in order to be configurable to determine a device ID associated with a particular mobile device in response to receiving a query comprising an IP address also associated with the particular mobile device.

In one exemplary embodiment the network entity comprises a presence server configured to collect and disseminate presence information relating to a mobile device. In another exemplary embodiment, the network entity comprises a presence network agent configured to publish presence information related to one or more mobile devices.

According to yet another aspect of the present invention, a method is provided for correlating one or more device identifiers associated with respective one or more mobile devices for use when publishing presence information relating to respective mobile devices. In one exemplary embodiment, the method includes updating a device identifier (ID) database with a device ID associated with a mobile device and correlated with an IP address also associated with the mobile device. The device ID database may, in turn, store and correlate one or more device IDs and one or more IP addresses associated with respective one or more mobile devices in order to be configurable to determine a device ID associated with a particular mobile device in response to receiving a query comprising an IP address also associated with the particular mobile device.

In one exemplary embodiment, the method further includes receiving a request to publish presence information relating to a mobile device, wherein the publication request includes a device ID associated with the mobile device. The method of this exemplary embodiment may further include ascertaining an IP address associated with the mobile device and determining, based at least in part on the IP address, whether a device ID associated with the mobile device has previously been stored in the device ID database. The method of one exemplary embodiment further includes, upon a determination that a device ID associated with the mobile device has not previously been stored in the device ID database, updating the device ID database with the device ID and IP address associated with the mobile device. The method may further include, upon a determination that a device ID associated with the mobile device has previously been stored in the device ID database, retrieving the previously stored device ID and transmitting the previously stored device ID to the mobile device. Alternatively, the method may include, upon a determination that a device ID associated with the mobile device has previously been stored in the device ID database, replacing the previously stored device ID in the device ID database with the device ID included in the publication request.

In another exemplary embodiment, the method further includes querying the device ID database for a device ID associated with a mobile device and generating a request to publish presence information related to the mobile device, wherein the publication request includes the device ID associated with the mobile device. The method of this exemplary embodiment may further include receiving, in response to querying the device ID database, the device ID associated with the mobile device. Alternatively, the method may further include generating the device ID associated with the mobile device where, in response to querying the device ID database, a device ID is not returned.

According to another aspect of the present invention, a mobile device is provided. In one exemplary embodiment, the mobile device comprises a processor and a memory in communication with the processor and storing an application executable by the processor. The application may be configured, upon execution, to generate a request to publish presence information relating to the mobile device, wherein the publication request includes a first device ID, and to receive, in response to the request, an acknowledgement including a second device ID.

According to yet another aspect of the present invention, a computer program product is provided for correlating one or more device identifiers associated with respective one or more mobile devices for use when publishing presence information relating to respective mobile devices. The computer program product contains at least one computer-readable storage medium having computer-readable program code portions stored therein. The computer-readable program code portions of one exemplary embodiment include a first executable portion for updating a device identifier (ID) database with a device ID associated with a mobile device and correlated with an IP address also associated with the mobile device, such that the device ID database stores and correlates one or more device IDs and one or more IP addresses associated with respective one or more mobile devices in order to be configurable to determine a device ID associated with a particular mobile device in response to receiving a query comprising an IP address also associated with the particular mobile device.

### BRIEF DESCRIPTION OF THE DRAWING

Having thus described the invention in general terms, reference will now be made to the accompanying drawing, which are not necessarily drawn to scale, and wherein:

FIG. 1 is a block diagram of one type of terminal and system that would benefit from embodiments of the present invention;

FIG. 2 is a schematic block diagram of a network entity, such as a Presence Network Agent (PNA) or Presence Server, in accordance with embodiments of the present invention;

FIG. 3 is a signal flow diagram of a publication sequence according to one embodiment of the present invention, wherein a device publishes first; and

FIG. 4 is a signal flow diagram of a publication sequence according to another embodiment of the present invention, wherein a PNA publishes first.

### DESCRIPTION OF THE INVENTION

The present inventions now will be described more fully hereinafter with reference to the accompanying drawing, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overall System, Terminal and Network Node:

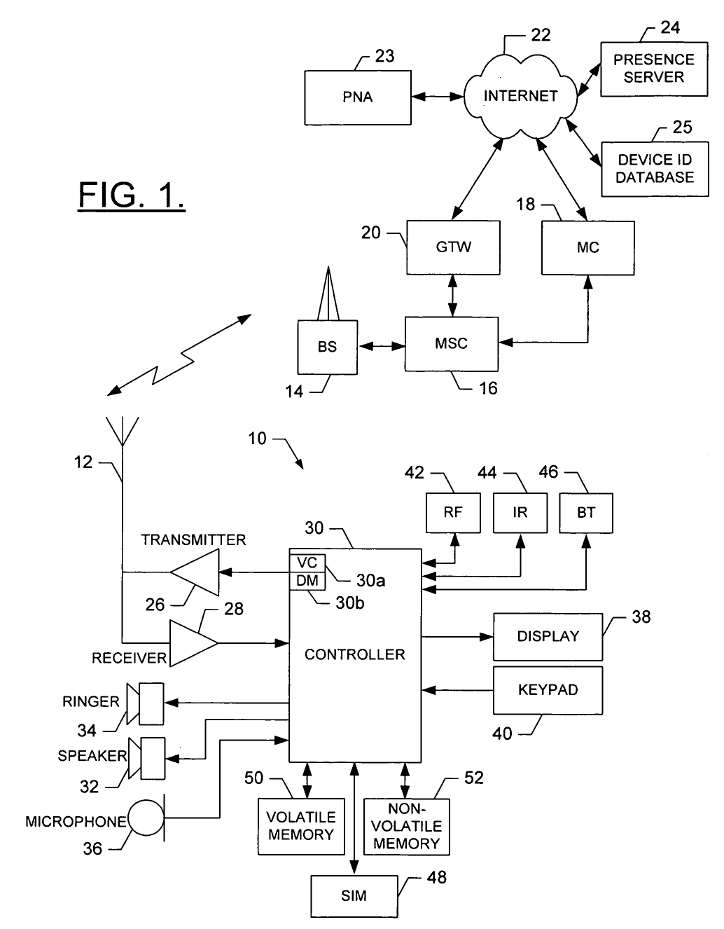

Referring to FIG. 1, an illustration of one type of system and terminal that would benefit from exemplary embodiments of the present invention is provided. The system, network entity, method, mobile device and computer program product of embodiments of the present invention will be primarily described in conjunction with mobile communications applications. It should be understood, however, that the system, network entity, method, mobile device and computer program product of embodiments of the present invention can be utilized in conjunction with a variety of other applications, both in the mobile communications industries and outside of the mobile communications industries. For example, the system, network entity, method, mobile device and computer program product of embodiments of the present invention can be utilized in conjunction with wireline and/or wireless network (e.g., Internet) applications.

Also, it should be understood that while the terminal may be illustrated and hereinafter described as comprising a mobile telephone, mobile telephones are merely illustrative of one type of terminal that would benefit from exemplary embodiments of the present invention and, therefore, should not be taken to limit the scope of the present invention. While several embodiments of the terminal are illustrated and will be hereinafter described for purposes of example, other types of terminals, such as personal digital assistants (PDAs), pagers, laptop computers and other types of electronic systems, can readily employ exemplary embodiments of the present invention.

As shown, the system can include a number of the same or different terminals 10 (one shown). Each terminal may have an antenna 12 for transmitting signals to and for receiving signals from a base site or base station (BS) 14. The base station is a part of one or more cellular or mobile networks that each include elements required to operate the network, such as a mobile switching center (MSC) 16. As well known to those skilled in the art, the mobile network may also be referred to as a Base Station/MSC/Interworking function (BMI). In operation, the MSC is capable of routing calls, data or the like to and from terminals when those terminals are making and receiving calls, data or the like. The MSC can also provide a connection to landline trunks when terminals are involved in a call. In addition, the MSC can be capable of controlling the forwarding of messages to and from terminals, and can also control the forwarding of messages for such terminals to and from a messaging center (MC) 18, such as Short Messaging Service (SMS) messages to and from a SMS center (SMSC) and/or Multimedia Messaging Service (MMS) messages to and from a MMS center (MMSC).

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a gateway (GTW) 20, and the GTW is coupled to a WAN, such as the Internet 22. In turn, devices such as processing elements (e.g., personal computers, server computers or the like) can be coupled to the terminals 10 via the Internet (and/or directly via other means for sharing and/or obtaining data, as explained below). For example, as explained below, the processing elements can include one or more processing elements associated with one or more Presence Network Agents (PNAs) 23, and/or Presence Servers 24. The processing elements can comprise any of a number of processing devices, systems or the like capable of operating in accordance with embodiments of the present invention. In this regard, the processing elements can comprise, for example, server computer systems, desktop computer systems, laptop computer systems or the like. Additionally, various databases, typically embodied by servers or other memory devices, can be coupled to the terminal 10 via the Internet. For example, as shown in FIG. 1, the databases may include a Device ID database 25, which may be accessible by the Presence Server 24, or, in an alternative embodiment, collocated with or part of the Presence Server 24.

Although not every element of every possible network is shown and described herein, it should be appreciated that the terminals 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. Additionally or alternatively, mobile network(s) can be capable of supporting communication in accordance with any one or more of a number of different digital broadcast networks, such as Digital Video Broadcasting (DVB) networks including DVB-T (DVB-Terrestrial) and/or DVB-H (DVB-Handheld), Integrated Services Digital Broadcasting (ISDB) networks including ISDB-T (ISDB-Terrestrial), or the like.

More particularly, for example, one or more terminals 10 may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data for GSM Evolution (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode terminals (e.g., digital/analog or TDMA/CDMA/analog phones).

As shown, in addition to an antenna 12, the mobile terminal 10 can include a transmitter 26, receiver 28, and controller 30 or other processor that provides signals to and receives signals from the transmitter and receiver, respectively. These signals include signaling information in accordance with the air interface standard of the applicable cellular system, and also user speech and/or user generated data. In this regard, the terminal can be capable of operating with one or more air interface standards, communication protocols, modulation types, and access types. More particularly, the terminal can be capable of operating in accordance with any of a number of 1G, 2G, 2.5G and/or 3G communication protocols or the like, such as any one or more of those indicated above.

It is understood that the controller 30 includes the circuitry required for implementing the audio and logic functions of the terminal 10. For example, the controller may be comprised of a digital signal processor device, a microprocessor device, and various analog-to-digital converters, digital-to-analog converters, and other support circuits. The control and signal processing functions of the terminal are allocated between these devices according to their respective capabilities. The controller can additionally include an internal voice coder (VC) 30a, and may include an internal data modem (DM) 30b. Further, the controller may include the functionality to operate one or more client software programs such as those indicated above, which may be stored in memory (described below).

The terminal 10 also comprises a user interface including a conventional earphone or speaker 32, a ringer 34, a microphone 36, a display 38, and a user input interface, all of which are coupled to the controller 30. Although not shown, the terminal can include a battery for powering the various circuits that are required to operate the terminal, as well as optionally providing mechanical vibration as a detectable output. The user input interface, which allows the terminal to receive data, can comprise any of a number of devices allowing the terminal to receive data, such as a keypad 40, a touch display (not shown) or other input device. In embodiments including a keypad, the keypad includes the conventional numeric (0-9) and related keys (#, *), and other keys used for operating the terminal.

The terminal 10 can also include one or more means for sharing and/or obtaining data. For example, the terminal can include a short-range radio frequency (RF) transceiver or interrogator 42 so that data can be shared with and/or obtained from electronic devices in accordance with RF techniques. The terminal can additionally, or alternatively, include other short-range transceivers, such as, for example an infrared (IR) transceiver 44, and/or a Bluetooth (BT) transceiver 46 operating using Bluetooth brand wireless technology developed by the Bluetooth Special Interest Group. The terminal can therefore additionally or alternatively be capable of transmitting data to and/or receiving data from electronic devices in accordance with such techniques. Although not shown, the terminal can additionally or alternatively be capable of transmitting and/or receiving data from electronic devices according to a number of different wireless networking techniques, including WLAN techniques such as IEEE 802.11 techniques or the like.

The terminal 10 can further include memory in communication with the controller 30 or processor and either embedded within or external to the controller 30 or processor. The memory may include a subscriber identity module (SIM) 48, a removable user identity module (R-UIM) or the like, which typically stores information elements related to a mobile subscriber. In addition to the SIM, the terminal can include other removable and/or fixed memory. In this regard, the terminal can include volatile memory 50, such as volatile Random Access Memory (RAM) including a cache area for the temporary storage of data. The terminal can also include other non-volatile memory 52, which can be embedded and/or may be removable. The non-volatile memory can additionally or alternatively comprise an EEPROM, flash memory or the like. The memories can store any of a number of software applications, instructions, pieces of information, and data, used by the terminal to implement the functions of the terminal.

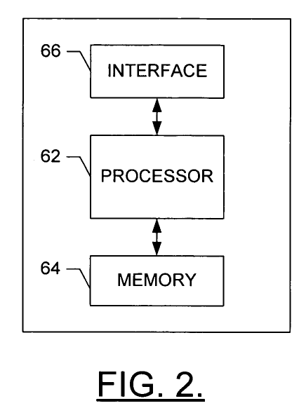

Reference is now made to FIG. 2, which illustrates a block diagram of a network entity (e.g., PNA 23, or Presence Server 24, etc.) within the public network, private networks or cellular networks, in accordance with one embodiment of the present invention. Although shown as separate entities, in some embodiments, one or more entities may support one or more of the network nodes, logically separated but co-located within the entit(ies).

As shown, the entity capable of operating as a network node can generally include a controller 62, processor or the like connected to and in communication with a memory 64, wherein the memory 64 may be embedded within or external to the controller 62 or processor. The controller can also be connected to at least one interface 66 or other means for transmitting and/or receiving data, content or the like. The memory can comprise volatile and/or non-volatile memory, and typically stores content, data or the like. For example, the memory typically stores software applications, instructions or the like for the controller to perform steps associated with operation of the entity in accordance with embodiments of the present invention. Also, for example, the memory typically stores content transmitted from, or received by, the network node.

Method of Correlating Device IDs in Mobile Networks:

In general, exemplary embodiments of the present invention provide a network-based Device ID database, along with a method of accessing and utilizing the database, which can be used in conjunction with any presence service to store binding, or correlating, information between the device IDs and device IP addresses for a plurality of devices communicating on the network. Exemplary embodiments of the invention are applicable to any type of device ID discussed above, including, for example, MAC addresses, ESNs, MSISDNs, IMEIs, or any random number that is unique to the particular device with which it is associated.

In the embodiments of the invention discussed below, Session Initiation Protocol (SIP) is used when communicating the publication requests between entities on the communication network, so as to advise the various entities of presence information. SIP is a calling model that provides Application layer signaling protocol related to multimedia sessions (see e.g., Internet Engineering Task Force (IETF) request for comment RFC 3261, entitled SIP: Session Initiation Protocol, June 2002, the contents of which are hereby incorporated by reference in its entirety). In particular, SIP is an IETF standard protocol for initiating an interactive user session that involves multimedia elements such as video, voice, chat, gaming, and virtual reality. Like Hypertext Transfer Protocol (HTTP) or Simple Mail Transfer Protocol (SMTP), SIP works in the Application layer of the Open Systems Interconnection (OSI) communications model. The Application layer is the level responsible for ensuring that communication is possible.

SIP can establish multimedia sessions or Internet telephony calls, and modify or terminate them. Furthermore, SIP also has the ability to request asynchronous notification about changes of event states (see IETF request for comment RFC 3265, entitled Session Initiation Protocol (SIP)-Specific Event Notification, June 2002), while the manipulation of the of event states happens via the SIP PUBLISH method (see IETF request for comment RFC 3903, entitled Session Initiation Protocol (SIP) Extension for Event State Publication, October 2004). The protocol can invite participants to unicast or multicast sessions that do not necessarily involve the initiator. Because the SIP supports name mapping and redirecion services, it makes it possible for users to initiate and receive communications and services from any location, and for networks to identify the users wherever they are. SIP is a request-response protocol, dealing with requests from clients and responses from servers. Participants are identified by SIP URLs. Requests can be sent through any transport protocol, such as User Datagram Protocol (UDP), Simple Control Transport Protocol (SCTP), or Transmission Control Protocol (TCP). SIP determines the end system to be used for the session, the communication media and media parameters, and the called party's desire to engage in the communication. Once these are assured, SIP establishes call parameters at either end of the communication, and handles call transfer and termination.

While the embodiments are discussed in terms of SIP, they are exemplary in nature, and therefore, do not limit the present invention to use with SIP. Rather, exemplary embodiments of the present invention can operate generally in accordance with other protocols that would be capable of collecting and publishing presence information.

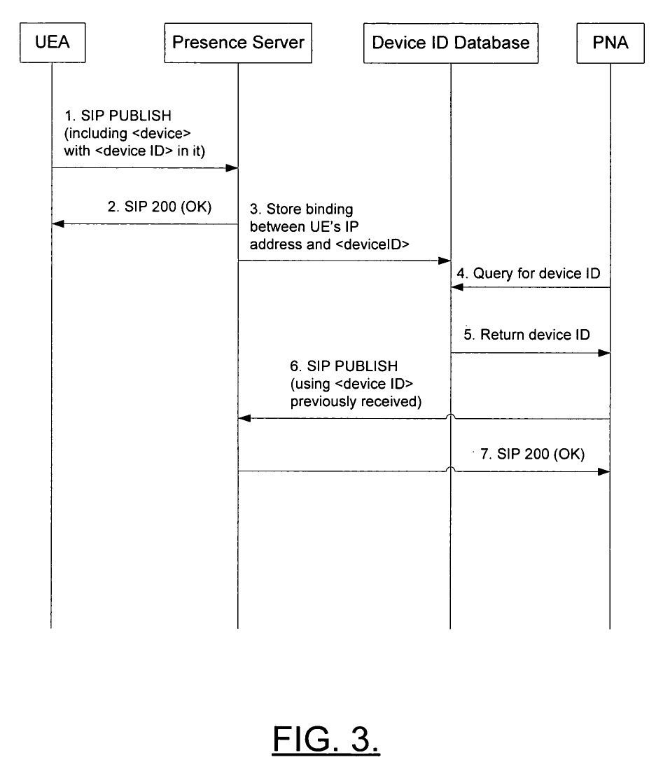

FIG. 3 is a signal flow diagram of a publication sequence according to one embodiment of the present invention, wherein the device requests publication of presence information prior to the Presence Network Agent (PNA) doing so on the device's behalf. As can be understood from this figure, in the first step, the mobile device, referred to as UE A (User Equipment A), transmits a SIP PUBLISH request to a Presence Server, which includes a device ID in the <device> element as part of the presence information represented as PIDF (Presence Information Data Format—see IETF request for comment RFC 3863, entitled Presence Information Data Format (PIDF), August 2004), placed in the payload of the SIP PUBLISH request. As stated above, the device ID may be any known unique identifier, such as a MAC address, ESN, IMEI, or a random number. The Presence Server acknowledges receipt of the request including the device ID, in step 2, by returning a SIP 200 OK response to the UE A. In step 3, the Presence Server stores the device ID generated by the device, along with binding, or correlating, information between the device ID and the device's IP address, which the Presence Server ascertained from the SIP PUBLISH request (e.g., via the header field), in a Device ID database.

Once the correlating information is stored in the Device ID database, the PNA can query the Device ID database for the UE A's device ID using the UE A's IP address, which is known to the PNA (step 4). As stated above, in general, the PNA will request publication of presence information any time there is a change in presence states, for example, any time there is a change in the availability of any of the devices communicating on the network. The Device ID database, in step 5, returns the unique device ID, which the PNA then uses, in step 6, to transmit a SIP PUBLISH request to the Presence Server that includes the device ID inserted in the PIDF's <device> element. Finally, in step 7, the Presence Server returns a SIP 200 OK response to the PNA acknowledging receipt of the publication request.

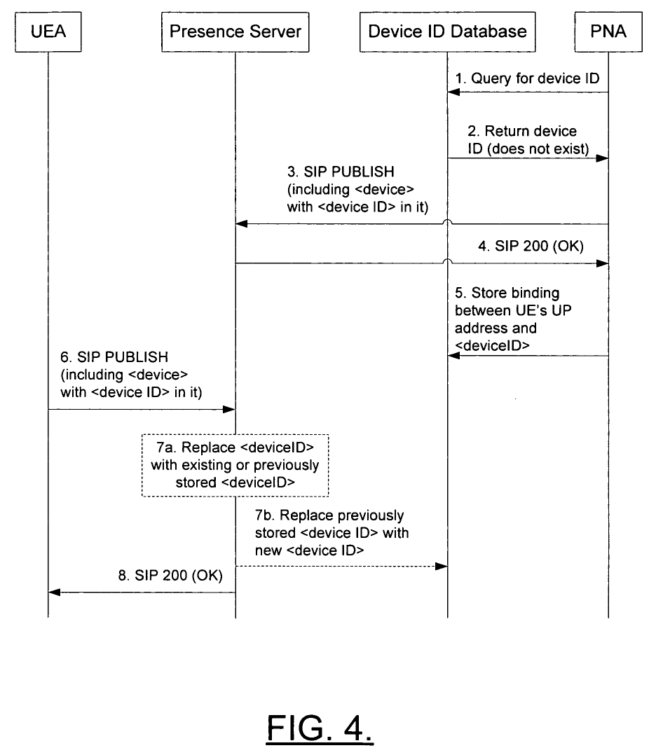

FIG. 4 is a signal flow diagram of a publication sequence according to another embodiment of the present invention, wherein the PNA publishes presence information on behalf of the mobile device, prior to the device itself doing so. According to this embodiment, in step 1, the PNA queries a Device ID database for the device ID associated with a particular device for which the PNA wishes to publish presence information. The PNA does so any time there is a change in the presence state of any device communicating on the network. The PNA queries the Device ID database for the device ID using the device's IP address, which is known to the PNA. However, because the mobile device has not previously published its presence information, the database returns an empty record to the PNA in step 2. Since there is no previous device ID stored in the Device ID database for that particular mobile device, the PNA generates one, and uses this device ID to issue a SIP PUBLISH request transmitted to the Presence Server in step 3 that includes the device ID assigned by the PNA in the device element. Once the PNA has received a SIP 200 OK response from the Presence Server (step 4), the PNA updates the Device ID database storing the binding, or correlating, information between the device ID assigned by the PNA and the device's IP address (step 5). This is in contrast to the previous embodiment, in which the mobile device published its presence information prior to the PNA attempting to do so on its behalf, wherein the mobile device, rather than the PNA, generated the device ID and transmitted it to the Presence Server, which in turn stored the binding, or correlating, information in the Device ID database.

In step 6, the mobile device (UE A) issues a SIP PUBLISH request to the Presence Server using a new device ID that was generated by the mobile device, as in step 1 of the previous embodiment. When the Presence Server receives the SIP PUBLISH request, it realizes that there has already been a previously allocated device ID associated with the IP address where the SIP PUBLISH request was issued from. In one exemplary embodiment, the Presence Server will, therefore, replace the device ID from the SIP PUBLISH request received from the UE A in step 6 with the previously used device ID as allocated by the PNA (Step 7a). Alternatively, the Presence Server may update the Device ID database by replacing the previously stored device ID with the newly received device ID (Step 7b). In step 8, the Presence Server transmits a SIP 200 OK response to the UE A including either the previously stored device ID (i.e., where Step 7a has been performed) or the device ID received from the UE A (i.e., where Step 7b has been performed).

In general, therefore, exemplary embodiments of the present invention create a Device ID database accessible by a Presence Server, which can be queried by a PNA for the device ID associated with a particular device when the PNA wishes to publish presence information on behalf of that device. The Device ID database stores the binding, or correlating, information between the device IDs and device IP addresses for a plurality of devices communicating on the network. In this regard, the PNA can advise a Presence Server of the presence information of the various devices, and the Presence Server can, therefore, collect and control the dissemination of the presence information to other entities communicating on the network.

### CONCLUSION

As described above and as will be appreciated by one skilled in the art, embodiments of the present invention may be configured as a system, network entity, method or mobile device. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for correlating one or more device identifiers associated with respective one or more mobile devices for use when publishing presence information relating to respective mobile devices, said system comprising:
a presence server; and
a device identifier (ID) database accessible by the presence server, said device ID database storing one or more device identifiers (IDs) associated with respective one or more mobile devices, said database further storing one or more IP addresses also associated with respective one or more mobile devices, wherein the database correlates the one or more device IDs and the one or more P addresses associated with respective mobile devices, such that the database is capable of providing a device ID associated with a particular mobile device in response to receiving a query comprising an IP address also associated with the particular mobile device.

2. The system of claim 1 further comprising:
at least one mobile device in communication with the presence server, said mobile device configured to generate a request to publish presence information related to the mobile device, wherein the publication request comprises a device ID associated with the mobile device, and to transmit the publication request to the presence server.

3. The system of claim 2, wherein the presence server is configured to receive the publication request, to ascertain an P address associated with the mobile device from the publication request, and to determine, based at least in part on the IP address, whether a device ID associated with the mobile device has previously been stored in the device ID database.

4. The system of claim 3, wherein the presence server is further configured, upon a determination that a device ID associated with the mobile device has not previously been stored in the device ID database, to update the device ID database with the device ID and IP address associated with the mobile device.

5. The system of claim 3, wherein the presence server is further configured, upon a determination that a device D associated with the mobile device has previously been stored in the device ID database, to retrieve the previously stored device ID and to transmit the previously stored device ID to the mobile device.

6. The system of claim 3, wherein the presence server is further configured, upon a determination that a device ID associated with the mobile device has previously been stored in the device ID database, to replace the previously stored device ID in the device ID database with the device ID included in the publication request.

7. The system of claim 1 further comprising:
a presence network agent in communication with the presence server and the device ID database, wherein the presence network agent is configured to query the device ID database for a device ID associated with a mobile device, to generate a request to publish presence information related to the mobile device, said request comprising the device ID associated with the mobile device, and to transmit the publication request to the presence server.

8. The system of claim 7, wherein the presence network agent is further configured to receive, in response to querying the device ID database, the device ID associated with the mobile device.

9. The system of claim 7, wherein the presence network agent is further configured to generate the device ID associated with the mobile device where, in response to querying the device ID database, a device ID is not returned.

10. The system of claim 9, wherein the presence network agent is further configured to update the device ID database with the generated device ID correlated with an IP address associated with the mobile device.

11. The system of claim 1, wherein the one or more device IDs are selected from the group consisting of an Electronic Serial Number (ESN), an International Mobile Equipment Identifier (IMEI) and a Media Access Control (MAC) address associated with respective one or more mobile devices.

12. A network entity configured to correlate one or more device identifiers associated with respective one or more mobile devices for use when publishing presence information relating to respective mobile devices, said network entity comprising:
a processor; and
a memory in communication with the processor, said memory storing an application executable by the processor, wherein the application is configured, upon execution, to:
update a device identifier (ID) database with a device ID associated with a mobile device and correlated with an IP address also associated with the mobile device such that the device ID database stores and correlates one or more device IDs and one or more IP addresses associated with respective one or more mobile devices in order to be configurable to determine a device ID associated with a particular mobile device in response to receiving a query comprising an IP address also associated with the particular mobile device.

13. The network entity of claim 12, wherein the network entity comprises a presence server configured to collect and disseminate presence information relating to a mobile device.

14. The network entity of claim 13, wherein the application is further configured, upon execution, to:
receive a request to publish presence information relating to a mobile device, said publication request comprising a device ID associated with the mobile device.

15. The network entity of claim 14, wherein the application is further configured, upon execution, to:
ascertain an IP address associated with the mobile device; and
determine, based at least in part on the IP address, whether a device ID associated with the mobile device has previously been stored in the device ID database.

16. The network entity of claim 15, wherein the application is further configured, upon execution, to:
upon a determination that a device ID has not previously been stored in the device ID database, update the device ID database with the device ID and IP address associated with the mobile device.

17. The network entity of claim 15, wherein the application is further configured, upon execution, to:
upon a determination that a device ID associated with the mobile device has previously been stored in the device ID database, retrieve the previously stored device ID and transmit the previously stored device ID to the mobile device.

18. The network entity of claim 15, wherein the application is further configured, upon execution, to:
upon a determination that a device ID associated with the mobile device has previously been stored in the device ID database, replace the previously stored device ID in the device BD database with the device ID included in the publication request.

19. The network entity of claim 12, wherein the network entity comprises a presence network agent configured to publish presence information related to one or more mobile devices.

20. The network entity of claim 19, wherein the application is further configured, upon execution, to:
query the device ID database for a device ID associated with a mobile device; and
generate a request to publish presence information related to the mobile device, said publication request including the device ID associated with the mobile device.

21. The network entity of claim 20, wherein the application is further configured, upon execution, to:
receive, in response to querying the device ID database, the device ID associated with the mobile device.

22. The network entity of claim 20, wherein the application is further configured, upon execution, to:
generate the device ID associated with the mobile device where, in response to querying the device ID database, a device ID is not returned.

23. A method of correlating one or more device identifiers associated with respective one or more mobile devices for use when publishing presence information relating to respective mobile devices, said method comprising:
updating a device identifier (ID) database with a device ID associated with a mobile device and correlated with an IP address also associated with the mobile device such that the device ID database stores and correlates one or more device IDs and one or more IP addresses associated with respective one or more mobile devices in order to be configurable to determine a device ID associated with a particular mobile device in response to receiving a query comprising an IP address also associated with the particular mobile device.

24. The method of claim 23 further comprising:
receiving a request to publish presence information relating to a mobile device, said publication request comprising a device ID associated with the mobile device.

25. The method of claim 24 further comprising:
ascertaining an IP address associated with the mobile device; and
determining, based at least in part on the IP address, whether a device ID associated with the mobile device has previously been stored in the device ID database.

26. The method of claim 25 further comprising:
upon determining that a device ID associated with the mobile device has not previously been stored in the device ID database, updating the device ID database with the device ID and IP address associated with the mobile device.

27. The method of claim 25 further comprising:
upon determining that a device ID associated with the mobile device has previously been stored in the device ID database, retrieving the previously stored device ID and transmitting the previously stored device ID to the mobile device.

28. The method of claim 25, further comprising:
upon determining that a device ID associated with the mobile device has previously been stored in the device ID database, replacing the previously stored device ID in the device ID database with the device ID included in the publication request.

29. The method of claim 23, fiber comprising:
querying the device ID database for a device ID associated with a mobile device; and
generating a request to publish presence information related to the mobile device, said publication request including the device ID associated with the mobile device.

30. The method of claim 29 further comprising:
receiving, in response to querying the device ID database, the device ID associated with the mobile device.

31. The method of claim 29, further comprising:
generating the device ID associated with the mobile device where, in response to querying the device ID database, a device ID is not returned.

32. A mobile device comprising:
a processor; and
a memory in communication with the processor, said memory storing an application executable by the processor, wherein the application is configured, upon execution, to:
generate a request to publish presence information relating to the mobile device, said publication request including a first device ID; and
receive, in response to the request, an acknowledgment comprising a second device ID.

33. The mobile device of claim 32, wherein the device ID is selected from the group consisting of an Electronic Serial Number (ESN), an International Mobile Equipment Identifier (IMEI) and a Media Access Control (MAC) address associated with the mobile device.

34. A computer program product for correlating one or more device identifiers associated with respective one or more mobile devices for use when publishing presence information relating to respective mobile devices, wherein the computer program product comprises at least one computer-readable storage medium having computer-readable program code portions stored therein, the computer-readable program code portions comprising:
a first executable portion for updating a device identifier (ID) database with a device ID associated with a mobile device and correlated with an IP address also associated with the mobile device such that the device ID database stores and correlates one or more device IDs and one or more IP addresses associated with respective one or more mobile devices in order to be configurable to determine a device ID associated with a particular mobile device in response to receiving a query comprising an IP address also associated with the particular mobile device.

35. The computer program product of claim 34 further comprising:
a second executable portion for receiving a request to publish presence information relating to a mobile device, said publication request comprising a device ID associated with the mobile device.

36. The computer program product of claim 35 further comprising:
a third executable portion for ascertaining an IP address associated with the mobile device; and
a fourth executable portion for determining, based at least in part on the IP address, whether a device ID associated with the mobile device has previously been stored in the device ID database.

37. The computer program product of claim 36 further comprising:
a fifth executable portion for, upon determining that a device ID has not previously been stored in the device ID database, updating the device ID database with the device ID and IP address associated with the mobile device.

38. The computer program product of claim 36 further comprising:
a fifth executable portion for, upon determining that a device ID associated with the mobile device has previously been stored in the device ID database, retrieving the previously stored device ID and transmit the previously stored device ID to the mobile device.

39. The computer program product of claim 36, further comprising:
a fifth executable portion for, upon determining that a device ID associated with the mobile device has previously been stored in the device ID database, replacing the previously stored device ID in the device ID database with the device ID included in the publication request.

40. The computer program product of claim 34, further comprising:
a second executable portion for querying the device ID database for a device ID associated with a mobile device; and
a third executable portion for generating a request to publish presence information related to the mobile device, said publication request including the device ID associated with the mobile device.

41. The computer program product of claim 40 further comprising:
a fourth executable portion for receiving, in response to querying the device ID database, the device ID associated with the mobile device.

42. The computer program product of claim 40, further comprising:
a fourth executable portion for generating the device ID associated with the mobile device where, in response to querying the device ID database, a device ID is not returned.
